(19) United States
(12) Patent Application Publication
(10) Pub. No.: US 2005/0258752 A1
(43) Pub. Date: Nov. 24, 2005

(54) Plasma display panel

(76) Inventor: Kyoung-Doo Kang, Suwon-si (KR)

Correspondence Address: CHRISTIE, PARKER & HALE, LLP, PO BOX 7068, PASADENA, CA, 91109-7068, US

(21) Appl. No.: 11/131,689

(22) Filed: May 17, 2005

(30) Foreign Application Priority Data
May 19, 2004 (KR) 10-2004-0035468

(51) Int. Cl. H01J 17/49

(52) U.S. Cl. 313/584

(57) ABSTRACT

A plasma display panel (PDP) which can realize low voltage driving, to thus reduce power consumption, and which can improve luminous efficiency through a long gap. The PDP includes a first substrate and a second substrate opposing each other, barrier ribs arranged in a space between the first substrate and the second substrate to define a plurality of discharge cells, phosphor layers formed in each of the plurality of discharge cells, address electrodes formed on the second substrate, and display electrodes provided on the first substrate. The display electrodes include igniter electrodes having ends protruding towards insides of the discharge cells, the igniter electrodes opposing the address electrodes within the discharge cells.

### CROSS-REFERENCE TO RELATED APPLICATION

This application claims priority to and the benefit of Korean Patent Application No. 10-2004-0035468 filed in the Korean Intellectual Property Office on May 19, 2004, the entire content of which is incorporated herein by reference.

### BACKGROUND OF THE INVENTION

1. Field of the Invention

The present invention relates to a plasma display panel (PDP) for display an image.

2. Description of the Related Art

Generally, a PDP is a display device in which vacuum ultraviolet (VUV) rays emitted from the plasma generated by gas discharge excite phosphors to emit red, green, and blue visible light and thereby realize predetermined images. The PDP can provide a large-scale screen of more than 60 inches with a thickness of less than 10 centimeters. Since the PDP is a self emission display device, it typically has no distortion due to view angle and has outstanding color reproduction. Moreover, its manufacturing process is simpler than that of an LCD, so the PDP has advantages in productivity and cost. Accordingly, the PDP has been highlighted for televisions and flat panel displays for industrial purposes.

In a typical AC PDP, address electrodes are formed along one direction on a rear substrate, and a dielectric layer is formed on an entire surface of the rear substrate, covering the address electrodes. Over the dielectric layer, a plurality of barrier ribs are formed in a stripe pattern between each of the address electrodes, and red, green and blue phosphor layers are formed between each of the barrier ribs.

Further, display electrodes having a pair of transparent electrodes and a pair of bus electrodes, are typically formed in a direction intersecting the address electrodes on a surface of a front substrate opposing the rear substrate. A dielectric layer and an MgO protective layer are formed sequentially covering the display electrodes.

Discharge cells are defined in the region where the address electrodes on the rear substrate intersect a pair of the display electrodes on the front substrate.

In the aforementioned PDP, more than a million matrix type discharge cell units are arranged. To simultaneously drive matrix type discharge cells of an AC PDP, a memory characteristic is used which will be described in more detail below.

In order to induce discharge between an X electrode and a Y electrode, forming a pair of display electrodes, a potential difference of not less than a predetermined critical voltage is required. The predetermined critical voltage is referred to a firing voltage Vf. An address voltage Va is applied between the Y electrode and the address electrode, and the discharge occurs forming plasma within discharge cells. This occurs because electrons and ions in the plasma shift toward electrodes with opposite polarities, thereby permitting the flow of electric current.

Dielectric layers are formed on the respective electrodes of the AC PDP. Most of the charge carriers (for example, electrons or ions) are deposited on whichever of the dielectric layers has polarity opposite that of the charge carrier. The net potential between the Y electrode and the address electrode is smaller than the originally applied address voltage Va, so that the discharge becomes weak, resulting in dissipation of address discharge. In such a case, a relatively small amount of electrons is deposited on the X electrode, while a relatively large amount of ions is deposited on the Y electrode. The charge deposited on the dielectric layer covering the X and Y electrodes is a wall charge Qw. A space voltage formed between the X and the Y electrodes due to the wall charge is a wall voltage Vw.

Subsequently, when a predetermined voltage, that is, a discharge sustain voltage Vs, is applied between the X electrode and the Y electrode of the selected discharge cell, plasma discharge is effected when the sum of the discharge sustain voltage Vs and the wall voltage Vw, that is, (Vs+Vw), exceeds a discharge firing voltage Vf. Accordingly, vacuum ultraviolet rays (VUVs) are emitted from discharge gas excited by plasma discharge. The VUVs excite phosphors so that they emit visible light through the transparent front substrate.

However, if any address discharge is not induced between the Y electrode and the address electrode, that is, if the address voltage Va is not applied thereto, no wall charge is deposited between the X and Y electrodes. As a result, no wall voltage exists between the X and Y electrodes. In such a case, only the discharge sustain voltage Vs applied between the X and Y electrodes is made within the discharge cell. Since the discharge sustain voltage Vs is lower than the firing voltage Vf, the gas space between the X and Y electrodes may not cause the discharge.

The PDP driven in the above-described manner undergoes several operational steps from inputting of power to finally obtaining of visible light. In this regard, on the one hand, in order to initiate sustain discharge, the X and Y electrodes are required to be rather close to each other or a considerably high sustain discharge voltage needs to be applied thereto. On the other hand, in order to increase the luminous efficiency through excitation of phosphor layers formed on discharge cells, a long gap must be maintained throughout the area where sustain discharge takes place.

### SUMMARY OF THE INVENTION

The present invention provides a plasma display PDP which can realize low voltage driving, to thus reduce power consumption, and which can improve luminous efficiency through a long gap.

According to an aspect of the present invention, there is provided a plasma display panel comprising a first substrate and a second substrate opposing each other, barrier ribs arranged in a space between the first substrate and the second substrate to define a plurality of discharge cells, phosphor layers formed in each of the plurality of discharge cells, address electrodes formed on the second substrate and extending along a first direction, and display electrodes provided on the first substrate, wherein the display electrodes include igniter electrodes having ends protruding towards insides of the discharge cells, the igniter electrodes opposing the address electrodes within the discharge cells.

The display electrodes include a pair of bus electrodes formed to correspond to the discharge cells while extending along a second direction intersecting the direction of the address electrodes on the first substrate, protrusion electrodes protruding toward centers of the discharge cells, and igniter electrodes protruding from the bus electrodes into the discharge cells to locate the ends between the protrusion electrodes, respectively.

The display electrodes may include a pair of an X electrode and a Y electrode are formed on the first substrate such that the pair of the X and Y electrodes corresponds to the discharge cells while extending along the second direction intersecting the address electrodes, and each of the X and Y electrodes include a pair of bus electrodes formed to correspond to the discharge cells while extending along the direction intersecting the length direction of the address electrodes on the first substrate, protrusion electrodes protruding toward the insides of the discharge cells from respective bus electrodes, and igniter electrodes protruding from respective opposing ones of the pair of bus electrodes and having ends located between the protrusion electrodes within the discharge cells.

The igniter electrodes may include expanded portions extending along the barrier ribs substantially parallel to the address electrodes, protruding portions protruding from the expanded portions toward the insides of the discharge cells, and opposing portions at ends of the protruding portions, each opposing portion configured to face a respective opposing portion from an opposing one of the pair of bus electrodes.

The opposing portions may have a width in the first direction greater than a width of the protruding portions while maintaining a predetermined space therebetween.

The opposing portions may have opposite sides of the same length in the first direction of the address electrodes. Alternatively, the opposing portions may have one relatively longer side than the opposite side.

The pair of opposing portions may have ends facing directions which cross at substantially a right angle with respect to the first direction.

The pair of opposing portions may have ends facing directions of which cross obliquely with respect to the first direction.

The X and Y electrodes of the igniter electrodes are formed to correspond to the centers of discharge cells.

The X and Y electrodes of the igniter electrodes may be formed to pass over the barrier ribs adjacent in the second direction, respectively.

The X and Y electrodes of the igniter electrodes may be symmetric to each other about a point of symmetry positioned at the centers of the discharge cells.

The igniter electrodes and the protruding portions and opposing portions thereof may be transparent electrodes.

In another aspect of the present invention, a sturcture for initiating sustain discharge in a plasma display panel is provided, the plasma display panel having a first substrate and a second substrate opposing each other, barrier ribs arranged in a space between the first substrate and the second substrate to define a plurality of discharge cells, phosphor layers formed in each of the plurality of discharge cells, address electrodes formed on the second substrate, and display electrodes formed on the first substrate, the display electrodes including pairs of bus electrodes with respective protrusion electrodes extending from respective bus electrodes into the discharge cells. Igniter electrodes are mounted to each of a respective pair of bus electrodes, the igniter electrodes having ends distal from the respective pair of bus electrodes and located between the protrusion electrodes, such that a gap between opposing faces of the ends may provide an initial sustain discharge in the respective discharge cell when a discharge sustain driving voltage is applied to the display electrodes. The opposing faces may be located between the protrusion electrodes such that the gap is at substantially a right angle with respect to the length direction of the address electrodes. The opposing faces may also be located between the protrusion electrodes such that the gap is oblique to the length direction of the address electrodes. Respective gaps may be formed to correspond to centers of respective discharge cells.

### BRIEF DESCRIPTION OF THE DRAWINGS

FIG. 1 is a schematic partial exploded perspective view of a PDP according to a first embodiment of the present invention.

FIG. 2 is a partial sectional view taken along line A-A shown in FIG. 1.

FIG. 3 is a partial sectional view taken along line B-B shown in FIG. 1.

FIG. 4 is a partial plan view of FIG. 1.

FIG. 5 is a partial plan view of a PDP according to a second embodiment of the present invention.

### DETAILED DESCRIPTION

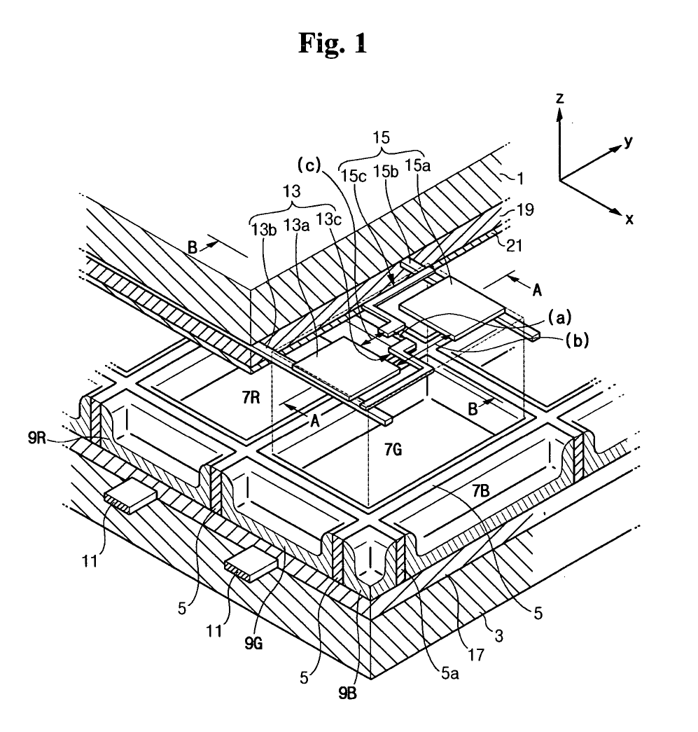

Turning now to the drawings, referring to FIG. 1, a PDP according to a first embodiment of the present invention has a first substrate 1 and a second substrate 3 which are spaced apart at a predetermined distance while facing each other. In the space between both of the substrates 1 and 3, a plurality of discharge cells 7R, 7G, 7B in which plasma discharge takes place are defined by a plurality of barrier ribs 5. Red (R), green (G) and blue (B) phosphors are printed to form phosphor layers 9R, 9G, 9B in the discharge cells 7R, 7G, 7B.

A plurality of the address electrodes 11 are formed along the y-axis direction of the drawing of the second substrate 3 on a surface of the second substrate 3. A plurality of display electrodes 13 and 15 are formed along the direction intersecting the plurality of address electrodes 11, that is, along the x-axis direction of the drawing, on the second substrate 3.

Barrier ribs 5 provided in the space between the first substrate 1 and the second substrate 3 are arranged to be substantially parallel with adjacent barrier ribs 5. Other barrier ribs 5a are arranged to intersect with the barrier ribs 5 and are substantially parallel with one another. The discharge cells 7R, 7G, 7B are defined by the barrier ribs 5 and 5a.

While closed barrier ribs, i.e., the barrier ribs 5 and 5a intersecting each other in the y- and x-axis directions to form the discharge cells 7R, 7G, 7B, have been described in the above-illustrative embodiment, it should be noted that the invention is also be applied to other types of barrier ribs, such a striped barrier ribs.

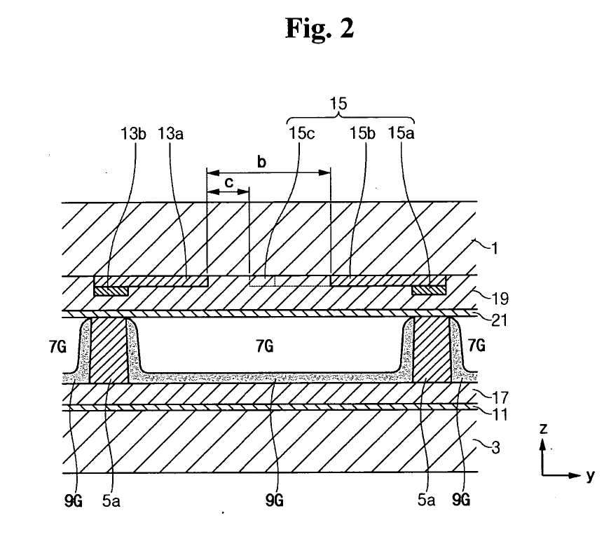

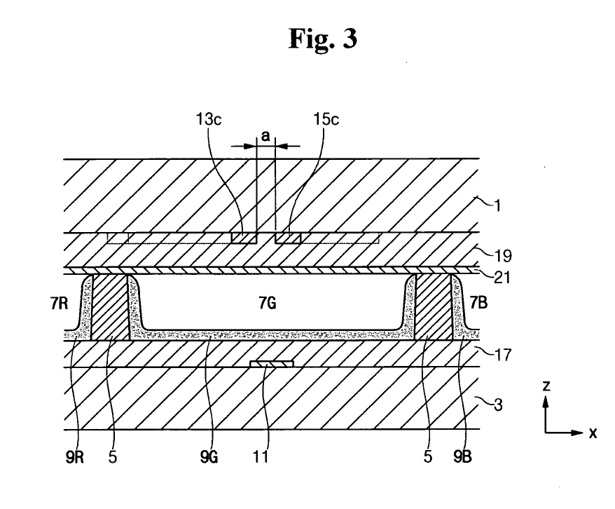

FIG. 2 is a partial sectional view taken along line A-A shown in FIG. 1, and FIG. 3 is a partial sectional view taken along line B-B shown in FIG. 1.

The address electrodes 11 are covered by a first dielectric layer 17 to induce address discharge by forming wall charges in the discharge cells 7R, 7G, 7B. In an exemplary embodiment the first dielectric layer 17 is preferably formed of a white dielectric material to ensure sufficient reflectivity for visible light.

The display electrodes 13 and 15 include an X electrode 13 and a Y electrode 15 arranged to face and opposite to each other in view of the discharge cells 7R, 7G, 7B to cause sustain discharge in the discharge cells 7R, 7G, after the address discharge.

The X electrode 13 and Y electrode 15 include protrusion electrodes 13a and 15a protruding toward centers of the discharge cells 7R, 7G, 7B, bus electrodes 13b and 15b for supplying current to the protrusion electrodes 13a and 15a, and igniter electrodes 13c and 15c protruding from the bus electrodes 13b and 15b into the discharge cells 7R, 7G, 7B and having ends located between the protrusion electrodes 13a and 15a, respectively.

Here, the protrusion electrodes 13a and 15a serve to induce plasma discharge in the discharge cells 7R, 7G, 7B, and in an exemplary embodiment are transparent electrodes made of transparent ITO (Indium Tin Oxide) in order to achieve brightness.

The bus electrodes 13b and 15b are provided for ensuring electrical conductivity by compensating for high resistance of the protrusion electrodes 13a and 15a, and in an exmplary embodiment are formed of a metallic material such as Aluminum.

As described above, the igniter electrodes 13c and 15c are arranged between the protrusion electrodes 13a and 15a, and have ends protruding toward centers of the discharge cells 7R, 7G, 7B to face each other. The facing direction that is, the direction indicated by an arrow corresponding to the short gap (a), in which the ends of the igniter electrodes 13c and 15c face each other, is in the x-axis direction and crosses the length direction of the address electrodes 11 (the y-axis), in the discharge cells 7R, 7G, 7B.

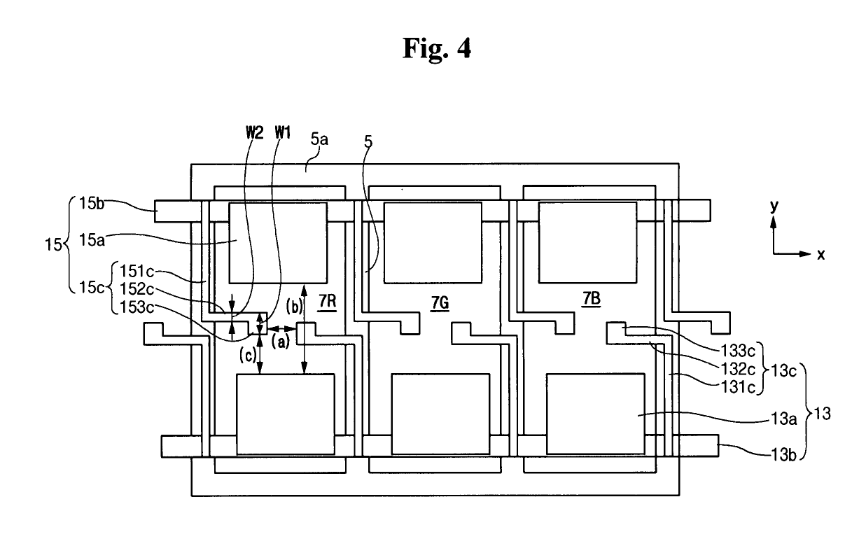

FIG. 4 is a partial plan view of FIG. 1. The igniter electrodes 13c and 15c will now be described in more detail. The igniter electrodes 13c and 15c facilitate initial sustain discharge before sustain discharge starts in the display electrodes 13 and 15 consisting of the X and Y electrodes 13 and 15 with a long gap (b) therebetween. The igniter electrodes 13c and 15c has a short gap (a) maintained therebetween to induce initial sustain discharge.

As described above, the long gap (b) between the protrusion electrodes 13a and 15a improves discharge efficiency, while the short gap (a) between the igniter electrodes 13c and 15c enables long gapped sustain discharge, so that initial sustain discharge can be made by low voltage driving, thereby ultimately reducing power required for driving the PDP. The igniter electrodes 13c and 15c enables sustain discharge through the short gap (a) at an initial sustain discharge requiring a high voltage, and then the protrusion electrodes 13a and 15a realize regular sustain discharge through the long gap (b). In other words, after inducing initial sustain discharge, the igniter electrodes 13c and 15c, which are contiguous with the protrusion electrodes 13a and 15a by a distance (c), cause surface discharge with the protrusion electrodes 13a and 15a, thereby finally making the protrusion electrodes 13a and 15a realize sustain discharge through the long gap (b).

The igniter electrodes 13c and 15c include expanded portions 131c and 151c extending along the barrier ribs 5 substantially parallel to the length direction of the address electrodes 11 (the y-axis direction of the drawing), protruding portions 132c and 152c protruding from the expanded portions 131c and 151c toward the insides of the discharge cells 7R, 7G, 7B, and opposing portions 133c and 153c opposing ends of the protruding portions 132c and 152c.

In an exemplary embodiment the expanded portions 131c and 151c extending along the barrier ribs 5 are linearly formed. The protruding portions 132c and 152c allow the opposing portions 133c and 153c to be positioned within the discharge cells 7R, 7G, 7B and protrude from the expanded portions 131c and 151c toward the insides of the discharge cells 7R, 7G, 7B. As in the illustrative embodiment the protruding portions 132c and 152c may be formed linearly, or they may be in another form. The opposing portions 133c and 153c function as igniters in the discharge cells 7R, 7G, 7B to arouse initial sustain discharge by low voltage. The opposing portions 133c and 153c are provided at ends of the protruding portions 132c and 152c with a predetermined gap maintained therebetween to be positioned between the protrusion electrodes 13a and 15c.

The opposing portions 133c and 153c have a width w1 in the length direction of the address electrodes 11 (in the y-axis direction of the drawing) greater than a width w2 of the protruding portions 132c and 152c. Such a relationship between the widths w1 and w2 shortens the distance (c) between each of the opposing portions 133c and 153c and each of the protrusion electrodes 13a and 15a opposing thereto while maintaining the short gap (a) between the opposing portions 133c and 153c, thereby easily making the initial sustain discharge that has occurred at the opposing portions 133c and 153c lead to surface discharge occurring between the opposing portions 133c and 153c and between the protrusion electrodes 13a and 15a.

The opposing portions 133c and 153c are substantially perpendicular to the length direction of the address electrodes 11, that is, the direction indicated by an arrow corresponding to the long gap (b) (the y-axis direction) and in an exemplary embodiment have opposite sides of the same length. In such a case, the pair of opposing portions 133c and 153c have ends whose facing directions (the x-axis direction of the drawing) are at right angles with respect to the length direction of the address electrodes 11 (the y-axis direction).

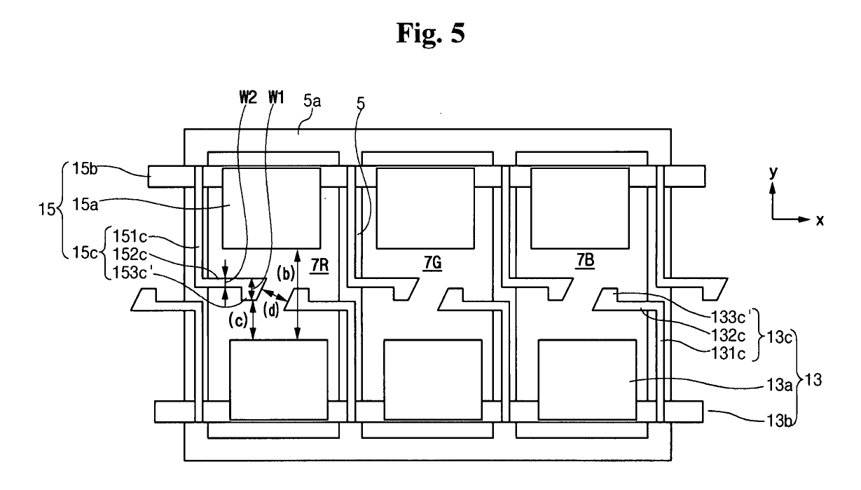

FIG. 5 is a partial plan view of a PDP according to a second embodiment of the present invention. The opposing portions 133c′ and 153c′ may be substantially perpendicular to the length direction of the address electrodes 11 (the y-axis direction of the drawing) and may have opposite sides of different lengths. In this case, the pair of opposing portions 133c′ and 153c′ have ends whose facing directions indicated by an arrow “d” cross the length direction of the address electrodes 11 (the y-axis direction) in a slanted manner.

As described above, the igniter electrodes 13c and 15c, which consist of the expanded portions 131c and 151c, the protruding portions 132c and 152c and the opposing portions 133c and 153c (and 133c′ and 153c′ for the second embodiment), are formed to correspond to the discharge cells 7R, 7G, 7B in the respective barrier ribs 5 adjacent in the direction of the length direction of the bus electrodes 13b and 15b (in the x-axis direction), the igniter electrodes 13c and 15c establishing a point of symmetry positioned about the center of the discharge cells 7R, 7G, 7B.

In addition, since the igniter electrodes 13c and 15c are positioned in luminous regions of the discharge cells 7R, 7G, 7B, in an exemplary embodiment they are transparent electrodes so as not to reduce brightness of the discharge cells 7R, 7G, 7B. In an exemplary embodiment, the protruding portions 132c and 152c and the opposing portions 133c and 153c (and 133c′ and 153c′ for the second embodiment) are transparent electrodes. Since the expanded portions 131c and 151c are arranged on non-luminous regions, that is, the barrier ribs 5, the expanded portions 131c and 151c can be formed with opaque electrodes.

As described above, the display electrodes 13 and 15 having the X and Y electrodes 13 and 15 further provided with the igniter electrodes 13c and 15c are covered with a second dielectric layer 19 and an MgO protective layer 21. The second dielectric layer 19 is preferably formed of a transparent dielectric material to increase transmittance of visible light.

In the PDP having the aforementioned configuration, a scan voltage is applied to the Y electrode 15 and an address voltage is applied to the address electrodes, address discharge is initiated, forming plasma within discharge cells 7R, 7G, 7B where a selected Y electrode 15 and the address electrodes 11 intersect each other. This occurs because electrons and ions in the plasma shift toward electrodes with opposite polarities, thereby permitting the flow of electric current.

Subsequently, the net potential between the Y electrode 15 and the address electrode 11 is smaller than the originally applied address voltage Va, so that the discharge become weak. Thus, the address discharge is dissipated. In such a case, a relatively small amount of electrons is deposited on the X electrode 13, while a relatively large amount of ions is deposited on the Y electrode 15. The wall charge deposited on the dielectric layer 19 covering the X and Y electrodes 13 and 15 produces a space voltage between the X and the Y electrodes 13 and 15.

If a discharge sustain voltage is applied between the X electrode 13 and the Y electrode 15, initial sustain discharge occurs at the igniter electrodes 13c and 15c, subsequently causing surface discharge to take place in two spaces among the discharge cells 7R, 7G, 7B, that is, in a space between the igniter electrode 13c and the protrusion electrode 15a and in a space between another igniter electrode 15c and another protrusion electrode 13a, which lead to surface discharge between the protrusion electrodes 13a and 15a. The VUV rays generated during sustain discharge excites phosphors in the pertinent discharge cells 7R, 7G, 7B to thus emit visible light through a front substrate.

As described above, initial sustain discharge, which has occurred between the igniter electrodes 13c and 15c with a short gap therebetween, leads to neighboring protrusion electrodes 13a and 15a spaced a short gap apart from the igniter electrodes 13c and 15c, thereby causing sustain discharge between the protrusion electrodes 13a and 15a, that is, sustain discharge can be made by low voltage driving.

As described above, in the PDP according to the present invention, a long gap is formed between protrusion electrodes of display electrodes, the protrusion electrodes having igniter electrodes, and a short gap is formed between the igniter electrodes and the protrusion electrodes while maintaining an appropriate distance between the igniter electrodes, thereby realizing sustain discharge by low voltage driving, ultimately reducing power consumption of the PDP and increasing the luminous efficiency by the long gap.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma display panel comprising:
a first substrate and a second substrate opposing each other;
barrier ribs arranged in a space between the first substrate and the second substrate to define a plurality of discharge cells;
phosphor layers formed in each of the plurality of discharge cells;
address electrodes formed on the second substrate; and
display electrodes formed on the first substrate,
wherein the display electrodes include igniter electrodes having ends protruding towards insides of the discharge cells, the igniter electrodes opposing the address electrodes within the discharge cells.

2. The plasma display panel of claim 1, wherein the display electrodes comprise:
a pair of bus electrodes formed on the first substrate to correspond to the discharge cells while extending along a direction intersecting a direction of the address electrodes;
protrusion electrodes protruding toward centers of the discharge cells from respective bus electrodes; and
igniter electrodes protruding from respective opposing ones of the pair of bus electrodes into the discharge cells to locate the ends between the protrusion electrodes, respectively.

3. The plasma display panel of claim 1, wherein the display electrodes comprise:
a pair of a first electrode and a second electrode formed on the first substrate such that the pair of a first electrode and a second electrode corresponds to respective discharge cells while extending along a direction intersecting a length direction of the address electrodes, the pair of a first electrode and a second electrode including a pair of bus electrodes formed to correspond to the respective discharge cells while extending along the direction intersecting a length direction of the address electrodes on the first substrate;
protrusion electrodes protruding toward the insides of the discharge cells from respective bus electrodes; and
igniter electrodes protruding from respective opposing ones of the pair of bus electrodes and having ends located between the protrusion electrodes within the discharge cells.

4. The plasma display panel of claim 3, wherein the igniter electrodes comprise:
expanded portions extending along the barrier ribs substantially parallel to the length direction of the address electrodes;
protruding portions protruding from the expanded portions toward the insides of the discharge cells; and
opposing portions at ends of the protruding portions, each opposing portion configured to face a respective opposing portion from an opposing one of the pair of bus electrodes.

5. The plasma display panel of claim 4, wherein the opposing portions have a width in the length direction of the address electrodes greater than a width of the protruding portions while maintaining a predetermined space therebetween.

6. The plasma display panel of claim 4, wherein the opposing portions have opposite sides of the same length in the length direction of the address electrodes.

7. The plasma display panel of claim 4, wherein the opposing portions have one relatively longer side than the opposite side in the length direction of the address electrodes.

8. The plasma display panel of claim 4, wherein the pair of opposing portions have ends whose facing directions cross at right angles with respect to the length direction of the address electrodes.

9. The plasma display panel of claim 4, wherein the pair of opposing portions have ends whose facing directions cross obliquely with respect to the length direction of the address electrodes.

10. The plasma display panel of claim 3, wherein the igniter electrodes are formed to correspond to centers of respective discharge cells.

11. The plasma display panel of claim 10, wherein the igniter electrodes are symmetric to each other about a point of symmetry positioned at the centers of the discharge cells.

12. The plasma display panel of claim 1, wherein the igniter electrodes are transparent electrodes.

13. The plasma display panel of claim 4, wherein the protruding portions and the opposing portions are transparent electrodes.

14. A structure for initiating sustain discharge in a plasma display panel, the plasma display panel having a first substrate and a second substrate opposing each other, barrier ribs arranged in a space between the first substrate and the second substrate to define a plurality of discharge cells, phosphor layers formed in each of the plurality of discharge cells, address electrodes formed on the second substrate, and display electrodes formed on the first substrate, the display electrodes including pairs of bus electrodes with respective protrusion electrodes extending from respective bus electrodes into the discharge cells, the sturcture comprising:
igniter electrodes mounted to each of a respective pair of bus electrodes, the igniter electrodes having ends distal from the respective pair of bus electrodes and located between the protrusion electrodes, such that a gap between opposing faces of the ends may provide an initial sustain discharge in the respective discharge cell when a discharge sustain driving voltage is applied to the display electrodes.

15. The structure of claim 14, wherein the opposing faces are located between the protrusion electrodes such that the gap is at substantially a right angle with respect to a length direction of the address electrodes.

16. The structure of claim 14, wherein the opposing faces are located between the protrusion electrodes such that the gap is oblique to a length direction of the address electrodes.

17. The structure of claim 14, wherein respective gaps are formed to correspond to centers of respective discharge cells.

18. The structure of claim 14, wherein the igniter electrodes are transparent electrodes.
